(19) United States
(12) Patent Application Publication
(10) Pub. No.: US 2013/0187025 A1
(43) Pub. Date: Jul. 25, 2013

(54) CAVITY FORMING PLUG FOR CONCRETE

(71) Applicant: Lloyd L. Lawrence, Denver, CO (US)

(72) Inventor: Lloyd L. Lawrence, Denver, CO (US)

(21) Appl. No.: 13/353,629

(22) Filed: Jan. 19, 2012

(51) Int. Cl. B29C 33/00; B25B 15/00

(52) U.S. Cl. 249/187.1; 81/436

(57) ABSTRACT

Plugs for forming voids in concrete anchors are disclosed herein. An embodiment of the plug includes a head with a shaft extending from the head. The shaft has a first end located proximate the head and an opposite second end with threads extending between the first end and the second end. The diameter of a thread proximate the first end of the shaft is greater than the diameter of a thread proximate the second end of the shaft.

### BACKGROUND

Plugs for concrete anchors (referred to herein simply as plugs) are disclosed herein. The plugs are used in threaded anchors during concrete pouring. More specifically, during construction of concrete items, an anchor is placed into the concrete in order to provide a device to move the concrete after it has cured. The anchor includes a threaded hole that is sized to receive a bolt or the like. After the concrete has set, the bolt is threaded into the hole and is used to move the concrete.

During pouring of the concrete, a plug is threaded into the anchor in order to prevent concrete from setting in the threaded portion of the anchor. The plug is removed after the concrete sets, which enables the bolt to be screwed into the anchor.

In many applications, the plugs are not readily removed from the anchor. Rather, the concrete sets to the plugs, so a great amount of torque has to be applied to the plugs in order to remove them. The torque causes the plugs to break inside the anchors. The broken plugs then need to be extracted, which is very time consuming.

### BRIEF DESCRIPTION OF THE DRAWINGS

FIG. 1 is a side elevation view of an embodiment of a plug for a concrete anchor.

FIG. 2 is an isometric view of the plug of FIG. 2 showing the interior of the head.

FIG. 3 is a plan view of the head of the plug of FIG. 1.

FIG. 4 is an isometric view of an embodiment of a tool that is insertable into the head of the plug in order to remove the plug from concrete.

FIG. 5 is a rear isometric view of the tool of FIG. 4.

FIG. 6 is an elevation view of the plug of FIG. 1 attached to a form with an anchor threaded onto the plug.

FIG. 7 is a side cutaway view of the concrete slab of FIG. 6 with an anchor in place and the plug removed from the anchor.

### DETAILED DESCRIPTION

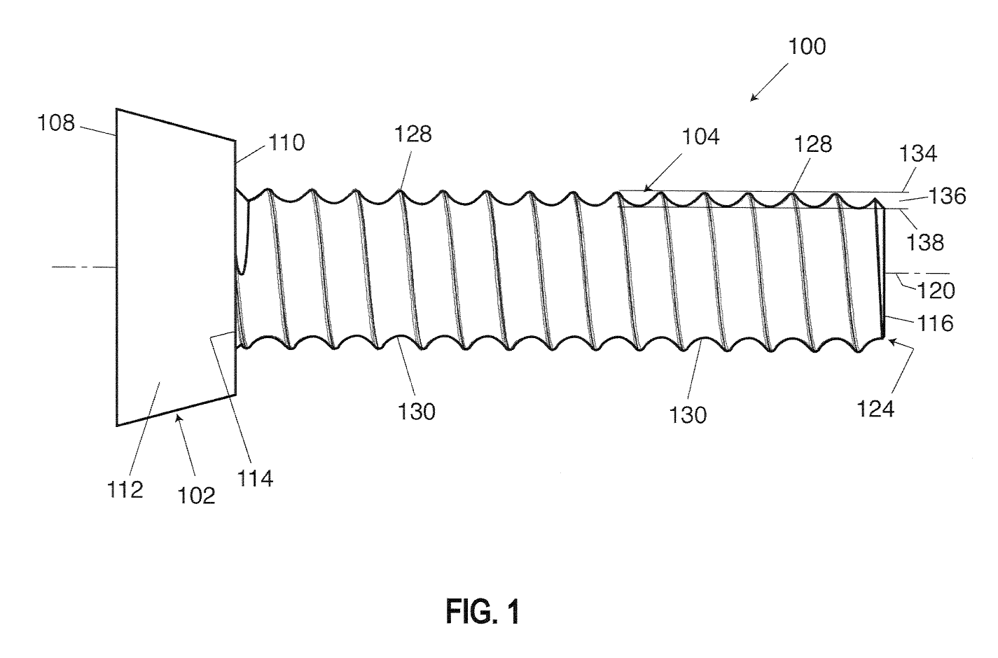

Plugs for insertion into concrete anchors are disclosed herein. The plugs disclosed herein are placed into the anchors prior to pouring concrete and are removed from the anchors after the concrete sets. The plugs disclosed herein are more easily removed from the anchors set in cured concrete than conventional plugs. An embodiment of a plug 100 is shown in FIG. 1, which is a side elevation view of the plug 100. The plug 100 has a head 102 and a shaft 104, wherein the shaft 104 is connected to and extends from the head 102. Both the head 102 and the shaft 104 may be fabricated as a single unit. The plug 100 may be made of plastic, such as polypropylene. Glass or other materials may be added to the plastic in order to strengthen the plug 100.

The head 102 has a first end 108 and a second end 110. As described in greater detail below, the first end 108 of the head 102 is open and is configured to receive a screwing tool. The second end 110 of the head 102 is connected to the shaft 104. The head 102 has an exterior surface 112 extending between the first end 108 and the second end 110. The exterior surface 112 is tapered wherein the diameter of the head 102 proximate the first end 108 is larger than the diameter of the head 102 proximate the second end 110. The tapered surface 112 facilitates the removal of the plug 100 from cured concrete as described below. In some embodiments, the taper of the surface 112 may be approximately fifteen degrees relative to the centerline of the shaft 104.

The shaft 104 has a first end 114 and a second end 116, wherein the first end 114 of the shaft 102 is connected to the second end 110 of the head 102. For reference purposes, an axis 120 extends through the center of the shaft 104 wherein the shaft 104, and the plug 100, are rotatable about the axis 120. Threads 124 extend along the shaft 104. In the embodiments described herein, the threads 124 extend the length of the shaft 104. However, in other embodiments, the threads 124 may only extend over a portion of the shaft 104.

The threads 124 are tapered from the first end 114 of the shaft 104 to the second end 116 of the shaft 104. As described below, the taper of the threads 124 enables the plug 100 to be easily removed from cured concrete. More specifically, as the threads 124 are removed, their contact with the concrete is eliminated, which eliminates the friction between the threads 124 and the concrete. The taper of the threads 124 can be described in many different embodiments. A first embodiment of the taper of the threads 124 is described by viewing the threads 124 from the side as in FIG. 1. The threads 124 have peaks 128, which are the widest diameter of the threads 124. The diameter of the threads 124 at the peaks 128 is sometimes referred to as the major diameter. The threads 124 also have troughs 130, which are the narrowest diameter of the threads 124. The diameters of the threads 124 at the troughs are sometimes referred to as the minor diameters. The diameters of the peaks 128 proximate the first end 114 of the shaft 104 may be greater than the diameters of the peaks 128 proximate the second end 116 of the shaft 104. Likewise, the diameters of the troughs 130 proximate the first end 114 of the shaft 104 may be greater than the diameters of the troughs 130 proximate the second end 116 of the shaft 104. In some embodiments, adjacent threads may have different diameters. In other embodiments, some adjacent threads may have the same diameter.

A second embodiment for the taper of the threads 124 is expressed with an axis 134 that extends along the peaks 128. It is noted that the axis 134 could also extend along the troughs 130. The axis 134 is able to intersect the axis 120. Because the threads 124 are tapered, the axes 134 and 120 are able to intersect. With conventional bolts, the threads are not tapered and, therefore, an axis central to the bolt could never intersect an axis extending along the peaks of the threads. For illustration purposes, an axis 138 is shown intersecting the axis 134 at an angle 136, wherein the axis 138 is parallel to the axis 120. The angle 136 may, as an example, be approximately zero degrees and five minutes. In other embodiments, the angle 136 may be zero degrees and ten minutes. The angle 136 is a design choice as will become more evident in the following description.

In some embodiments, the distances between the peaks 128 and the troughs 130 of the threads 124 remains substantially constant over the distance of the threads. The taper is achieved by the shaft 104 on which the threads 124 are located being tapered.

The plug 100, including the threads 124 and the surface 112 may be fabricated from a smooth material, such as polypropylene or other plastics. A smooth material does not have enough pores or pores large enough for concrete to set therein. If concrete sets to the surface 112 or the threads 124, the concrete substantially inhibits removal of the plug 100 from an anchor in cured concrete. For example, some conventional plugs are made from materials that enable concrete to cure to them. When these conventional plugs are attempted to be removed from the concrete, the concrete is secured to them so tightly that the plugs break. The use of a smooth material, such as a propylene reduces the chances of concrete setting to the plug 100.

In order to further lessen the likelihood that concrete sets to the plug 100, the plug 100 may be coated with a removable substance or coating, such as wax. For example, the surface 112 and/or the threads 124 may be coated with the removable coating. The concrete may adhere slightly to the removable coating, which is then stripped away from the plug 100 as the plug 100 is extracted from the concrete. Accordingly, the concrete does not set to the plug 100. The use of the removable coating may be used with plugs having conventional or non-tapered threads.

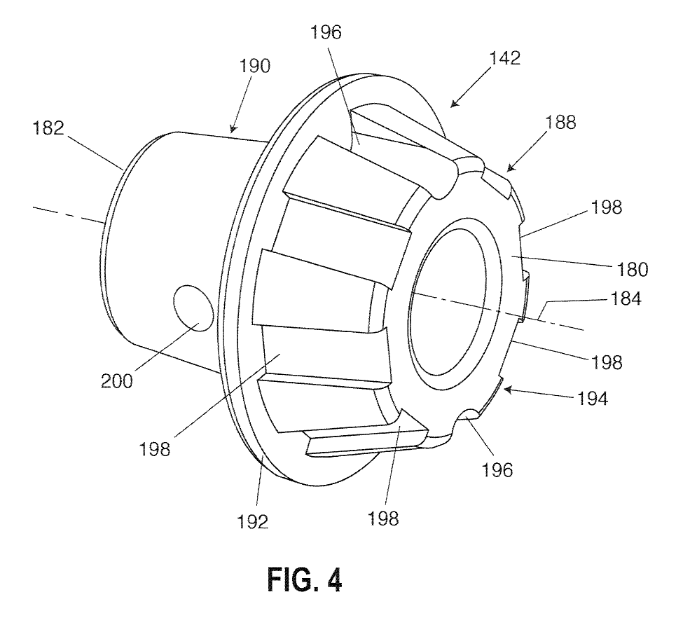

Having described the shaft 104, the head 102 will now be described. The first end 108 of the head 102 has an opening 140 that enables a tool 142, FIG. 4, described below, to enter the head 102. The head 102 has an inner surface 144 with a plurality of protrusions 146 extending inward from the inner surface 144. The head 102 has a lower surface 148 that defines the inner most extent of the opening 140. The head 102 has a thickness 150 extending between the inner surface 144 and the outer surface 112. The thickness may, as an example, be approximately 0.14 inches. The diameter of the first side 108 of the head 102 may be approximately 2.1 inches and the diameter of the second side 110 of the head 102 may be approximately 1.65 inches. The distance between the first end 108 and the second end 110 of the head 102 may be approximately 0.77 inches. The outer surface 112 of the head may taper approximately fifteen degrees relative to the axis 120 or relative to a plane parallel to the lower surface 148.

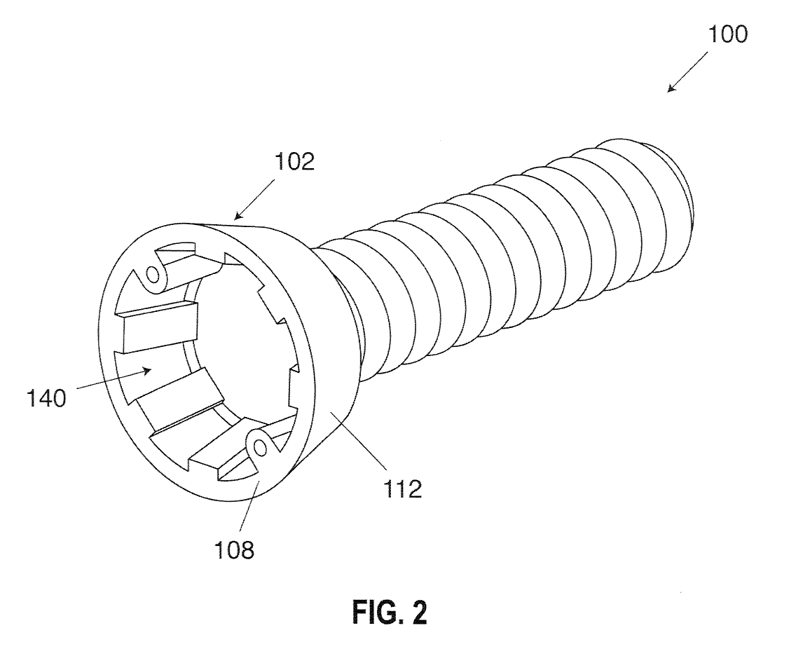

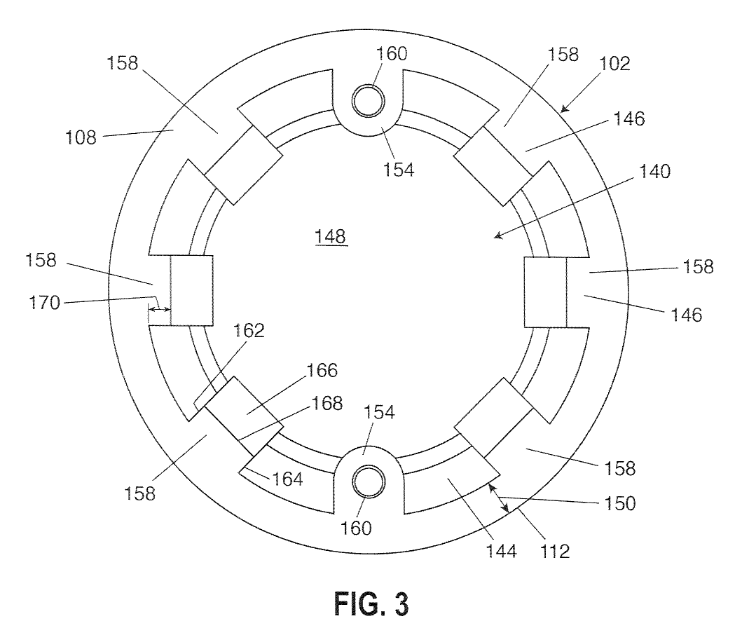

The head 102 of FIGS. 2 and 3 has eight protrusions 146 extending from the inner surface 144 into the opening 140. Six of the protrusions 146 are substantially rectangular and two are substantially semi-circular. The semi-circular protrusions 154 are opposite each other. Three rectangular protrusions 158 are located on each side of the semi-circular protrusions 154 as shown in FIG. 3. The protrusions 146 are sized to be received in recessed portions of the tool 142 as described in greater detail below. The semi-circular protrusions 154 have holes 160 located therein and may extend to the lower surface 148 or through the lower surface 148. The holes 160 serve to affix the plug 100 to a form during the pouring of concrete. For example, a form may be affixed to the first end 108 of the head 102 by way of screws threaded into the holes 160. The form abuts the first end 108 of the head 102 in order to prevent concrete from entering into the opening 140.

The rectangular protrusions 158 each have a first wall 162 and a second wall 164 that are joined by a third wall 166, which has an edge 168. The first wall 162 and the second wall 164 extend into the opening 140 a distance 170, which enables the tool 142 to engage the rectangular protrusions 158 as described in greater detail below. To further enhance engagement with the tool 142, the first wall 162 and the second wall 164 are substantially flat. In addition, the edge 168 is parallel to a line that is tangent to a point located midway between points where both the first wall 162 and the second wall 164 intersect the inner surface 144. The distance 170 may extend the length of the first wall 162 and the second wall 164 from the first end 108 to the lower surface 148, which enhances the ability of the tool 142 to contact the rectangular protrusions 158.

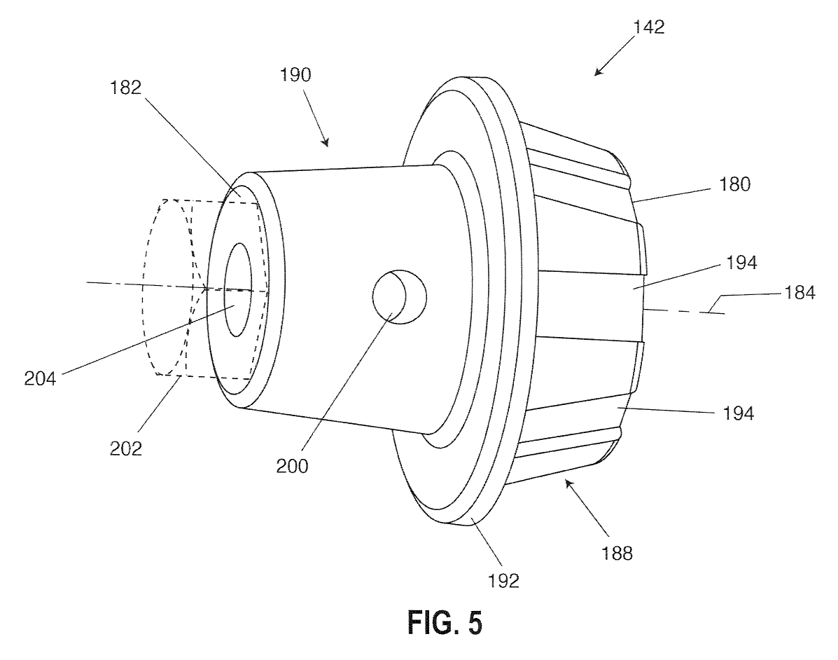

Having described the plug 100, the tool 142, FIG. 4, will now be described. Additional reference is made to FIG. 5, which is a rear isometric view of the tool 142 of FIG. 4. The tool 142 serves to fit into the opening 140 of the head 102 of the plug 100 in order to turn the plug 100 and remove it from a threaded anchor that is set in concrete. The tool 142 has a first end 180 and a second end 182. An axis 184 extends between the first end 180 and the second end 182, wherein the tool 142 is rotatable about the axis 184. In use, the first end 180 may contact the lower surface 148 of the head 102. The second end 182 may be configured to receive a tool, such as a wrench, that is able to turn the tool 142.

The tool 142 has a first portion 188 and a second portion 190. The embodiments of the tool 142 described herein have a disc 192 located between the first portion 188 and the second portion 190. The first portion 188 has a plurality of recesses 194 that are matched to the protrusions 146 in the head 102 of the plug 100. More specifically, the first portion 188 has two semi-circular recesses 196 and six rectangular recesses 198. The first portion 188, including the recesses 194, is tapered to match the taper of the opening 140 in the head 102 of the plug 100.

The second portion 190 provides a mount for a tool that is used to rotate the tool 142. The second portion 190 may have a hole 200 located therein. A rod (not shown) may be inserted through the hole 200 and may be used to rotate the tool 142. In other embodiments, a bolt 202 may be threaded into or otherwise located in a hole 204 wherein the head of the bolt 202 is accessible. A set screw (not shown) or other securing device may be threaded into the hole 200 in order to secure the bolt 202 to the tool 142. In other embodiments, a dowel may be pressed into the hole 200 in order to secure the bolt 202 in the hole 204. A user may attach a wrench to the head of the bolt 202 in order to rotate the tool 142. In other embodiments, the hole 204 is configured to receive a tool. For example, the hole 204 may be configured to receive an alien or torx wrench.

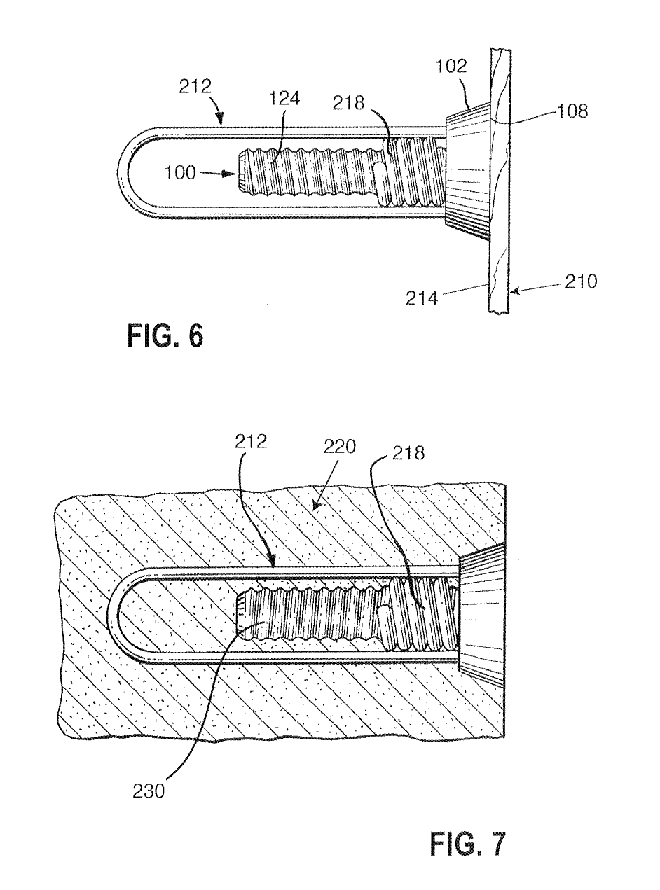

The use of the plug 100 and the tool 142 will now be described. Reference is made to FIG. 6, which is an elevation view of the plug 100 attached to a form 210. An anchor 212 is threaded onto the shaft 104 of the plug 100. The use of the plug 100 commences with it being attached to a first side 214 of the form 210. The first side 214 of the form 210 is the side that contacts the concrete. Nails or other securing devices may be placed through the holes 160, FIG. 3, in the semi-circular protrusions 154 in the head 102 and secured to the frame 210. The first side 108 of the head 102 may form a seal with the first side 214 so that concrete does not enter the opening 140, FIG. 3, of the head 102.

The anchor 212 has threads 218 affixed thereto, wherein the threads 218 of the anchor 212 match the threads 124 of the plug 100. Ideally, the threads 124, 218 are matched tight enough so that a minimal amount of uncured concrete is able to seep between the threads 124, 218. Although, the threads 218 on the anchor 212 are not tapered, the taper of the threads 124 is small enough that residual concrete seeping between the threads 124, 218 will not adversely affect the use of the anchor 212. The threads 218 are typically very large and made from a strong material, such as steel, that is strong enough to support the cured concrete that is poured into the form 210. The anchor 212 is screwed to the plug 100 by threading the threads 218 of the anchor 212 onto the threads 124 of the plug 100.

After the anchor 212 is secured to the plug 100, concrete is poured into the form in a conventional manner. The concrete will set to or around the anchor 212 so that the anchor 212 is secured within the concrete. The smooth surface of the plug 100 and/or the removable coating on the plug 100 reduces the possibility of concrete setting to the plug 100.

Additional reference is made to FIG. 7, which is a cut away view of the concrete 220 with the anchor 212 in place and the form 210 and plug 100 removed. After the concrete 220, FIG. 7, has set, the form 210 is removed. With additional reference to FIGS. 2, 3, and 4, at this point, the opening 140 in the head 102 of the plug 100 is exposed. The first portion 188 of the tool 142 is inserted into the opening 140 of the head 102. The recesses 194 in the first portion 188 are received in the protrusions 154, 156 of the head 102. In order to assure a good fit, the tool 142 may be inserted into the head 102 so that the first side 180 contacts the lower surface 148 of the head 102 or the disc 192 contacts the second end 108 of the head.

When the tool 142 is inserted into the head 102, the tool 142 is rotated to remove the plug 100. Conventional plugs are not easily removed from cured concrete and may break as attempts are made to remove them. In some circumstances, the concrete cures to the threads. During removal, the treads cannot turn relative to the concrete and the plug breaks. In other circumstances, the threads can rotate, but the rotation is very difficult due to the friction between the threads and the concrete. As described above, some embodiments of the plug 100 are coated in a removable substance, such as wax. The coating prevents the concrete from adhering to the plug 100. In some embodiments, the concrete may adhere to the coating, but because the coating is removable from the plug 100, the concrete does not adhere to the plug 100. Accordingly, the plug 100 is readily removed from the set concrete.

The tapered threads 124 further enable the plug 100 to be readily removed from the anchor 212 and the concrete 220. As the plug 100 is turned in the threads 218 of the anchor 212, smaller diameter threads 124 are moved in the place of larger diameter threads 124. Therefore, any tight fit due to the concrete is alleviated by the taper in the threads 124. In some embodiment, one half of a turn of the plug 100 removes the pressure applied by the concrete and provides for easy removal of the plug 100.

The fit of the tool 142 in the head 102 of the plug 100 further eases the removal of the plug 100 from the anchor 212. Conventional plugs use a tool that applies a force to points that are substantially in the center of the head. Typically, the force is applied to only two points. The application of the force creates a tremendous torque between the head and the shaft. When combined with the other problems associated with removing conventional plugs, the high torque causes the heads to break from the shafts. The plugs then have to be extracted from the anchors, which is very time consuming if it can be done at all. In some circumstances, the portion of the head that receives the tool will shear off or otherwise break, which requires the time consuming extraction of the plug.

The tool 142 described herein applies force to eight points in the head 102, which are the above-described protrusions 154, 158. The protrusions 154, 158 are located on the outer periphery of the head 102, so the torque that may be applied to the shaft 104 is greater than the torque that may be applied by conventional tools operating with conventional plugs. As described briefly above, conventional tools apply torque to the central region of the heads of the plugs at two points. This application of the torque tends to break the heads, which leaves the plugs stuck in the concrete. The application of torque with the plug 100 described herein is via the outer periphery of the head 102 and is applied at a several points. Accordingly, the head 102 is less likely to fail than conventional heads.

When the plug 100 is extracted from the concrete, a threaded hole 230, FIG. 7, remains in the concrete 220 and in the threads 218 of the anchor 212. A bolt or other threaded device (not shown) may be screwed into the anchor 212 in order to move the concrete in a conventional manner by use of the threaded device.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

1. A plug for forming a void in a concrete anchor, said plug comprising:
a head;
a shaft extending from said head, said shaft having a first end located proximate said head and an opposite second end, said shaft having threads extending: between said first end and said second end:
wherein the diameter of a thread proximate said first end of said shaft is greater than the diameter of a thread proximate said second end of said shaft.

2. The plug of claim 11, wherein said threads have diameters, and wherein the diameter of said threads decrease linearly from said first end of said shaft to said second end of said shaft.

3. The ping of claim 1, wherein:
said shaft extends along a central axis that is central to said shaft;
said threads have peaks associated therewith, said peaks extend along an exterior axis between said first end and said second end of said shaft; and
said central axis and said exterior axis are able to intersect.

4. The plug of claim 3, wherein said central axis and said exterior axis intersect at an angle of approximately zero degrees and five minutes.

5. The plug of claim 3, wherein said central axis and said exterior axis intersect at an angle of approximately zero degrees and ten minutes.

6. The of claim 1, wherein said plug has an exterior surface and wherein concrete does not adhere to at least a portion said exterior surface.

7. The plug of claim 1, wherein at least a portion of said plug has an exterior coaling, wherein said exterior coating is removable from said plug as said plug is extracted from concrete.

8. The plug of claim 7, wherein said exterior coating is wax.

9. The plug of claim 1, wherein said head has a first end and an opposite second end, said second end being adjacent said shaft, and wherein said first end has an opening.

10. The plug of claim 9, and further comprising a plurality of protrusions extending into said opening.

11. The plug of claim 10, wherein at least one of said protrusions is substantially rectangular.

12. A plug for forming a void in a concrete anchor, said plug comprising:
a head having a first end and a second end, wherein said first end has an opening with an interior surface, and wherein a plurality of protrusions extend from said interior surface into said opening; and
a shaft extending from said second end of said head, said shaft having a first end located proximate said head and an opposite second end, said shaft having threads at least partially extending between said first end and said second end.

13. The plug of claim 12, wherein said opening has a surface located opposite said first end of said head, and wherein at least one of said protrusions extends from said first end of said head to said surface.

14. The plug of claim 12, wherein at least one of said protrusions is rectangular.

15. The plug of claim 12, wherein a tool is receivable in said opening said tool having recesses that receive said protrusions when said tool is received in said opening.

16. The plug of claim 12, wherein said threads have diameters, and wherein the diameter of said threads proximate said first end of said shaft is greater then the diameter of said threads proximate said second end of said shaft.

17. The plug of claim 12, wherein said threads have diameters, and wherein the diameter of said threads decrease linearly from said first end of said shaft to said second end of said shaft.

18. The plug of claim 12, wherein said threads have diameters, and wherein the diameter of said threads decrease linearly from said first end of said shaft to said second end of said shaft at an angle of between zero degrees, five minutes and zero degrees, fen minutes relative to a central axis of said shaft.

19. A tool for removing a plug in concrete, wherein said plug leaves a void in said concrete, said plug having a head with an opening, wherein said opening has a plurality of protrusions extending into said opening, said tool comprising:
a first portion that is receivable in said opening; and
a plurality of recesses located around the exterior of said first portion, wherein said protrusions are receivable in said recesses.

20. The tool of claim 19 and further comprising a second portion, wherein said second portion comprises a fixture for attaching a wrench to said second portion.

21. A plug for forming a void in a concrete anchor, wherein said anchor has a threaded hole, said plug comprising:
a shaft having threads located thereon; and
a removable coating on at least a portion of said threads, wherein said removable coating prevents concrete from setting to said threads.

22. The plug of claim 21, wherein said removable coating is wax.
